(19) United States
(12) Patent Application Publication
(10) Pub. No.: US 2026/0184405 A1
(43) Pub. Date: Jul. 2, 2026

(54) VEHICLE RAMP

(71) Applicant: Frank Jay Brown, Webb City, MO (US)

(72) Inventor: Frank Jay Brown, Webb City, MO (US)

(21) Appl. No.: 19/007,209

(22) Filed: Dec. 31, 2024

(51) Int. Cl. B63B 27/14; A61G 3/06; B60P 1/43; B60P 3/10

(52) U.S. Cl. CPC B63B 27/143; A61G 3/061; B60P 1/431; B60P 3/1033

(57) ABSTRACT

A vehicle ramp has a fixed member attached to the underside of a vehicle and a sliding member that slides in and out of the fixed member. The sliding member is captivated within the fixed member so the sliding member cannot be inadvertently removed from the fixed member during normal use of the vehicle ramp. The fixed member includes a support member upon which a portion of the sliding member rests when the sliding member is fully slid out of the fixed member to a fully deployed position and pivoted downward, thereby defining a maximum angle of the sliding member with respect to the fixed member. This angle is preferably less than 45 degrees below horizontal.

### BACKGROUND

### 1. Technical Field

This invention generally relates to ramps, and more specifically relates to ramps attached to vehicles.

### 2. Background Art

Various ramps have been used over the ages for loading people and other things onto different types of vehicles. One known ramp is attached to the underside of a pontoon boat, and includes a sliding portion captivated within a fixed portion that is attached to the pontoon boat so the sliding portion can be slid out of the fixed portion and deployed to the bank of a lake by pivoting the sliding portion down until the end of the sliding portion rests on the ground, thereby allowing people to easily climb into the pontoon boat.

The known ramp for pontoon boats makes it much easier to load people, cargo and dogs onto the pontoon boat from the bank of a lake. However, the known ramp is not designed to be used when the pontoon boat is out on the lake. If a person were to slide the known ramp out while on the water, the sliding portion of the ramp would fall into the water, and would end up at an angle where the ramp is not usable as a ramp.

Many pontoon boat owners love to take their dogs to the lake. Many dogs love to swim and play in the water. But when a pontoon boat is out on the lake, the known ramp is not useful, because it is designed for the end to rest on the ground, such as at a bank of the lake. When a dog jumps off a pontoon boat to go swimming, it has a hard time getting back on the pontoon boat. The owner must generally lift the dog from the water onto the deck of the pontoon boat, which can be a very awkward and physically demanding process, especially for a large dog. Sometimes two people cooperate to get a large dog from the water back on the deck of a pontoon boat, with one in the water pushing the dog upward and a second on the deck of the boat pulling the dog upward. These and other deficiencies of the known boat ramps are solved by the vehicle ramp disclosed herein.

### BRIEF SUMMARY

A vehicle ramp has a fixed member attached to the underside of a vehicle and a sliding member that slides in and out of the fixed member. The sliding member is captivated within the fixed member so the sliding member cannot be inadvertently removed from the fixed member during normal use of the vehicle ramp. The fixed member includes a support member upon which a portion of the sliding member rests when the sliding member is fully slid out of the fixed member to a fully deployed position and pivoted downward, thereby defining a maximum angle of the sliding member with respect to the fixed member. This angle is preferably less than 45 degrees below horizontal. When mounted to the underside of a boat, the sliding member can be deployed while the boat is on the water, with the result that the sliding member will have one end in the water at the angle defined by the support member, thereby allowing people or dogs to use the ramp to climb back into the boat after swimming in the water.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a side view of a prior art ramp for a pontoon boat;

FIG. 2 is a front view of the prior art ramp taken along the line 2-2 shown in FIG. 1;

FIG. 3 is a side view showing the prior art ramp of FIGS. 1 and 2 deployed to pivot down and touch the ground;

FIG. 4 is a side view showing the that the prior art boat ramp in FIGS. 1-3 would not be suitable for us as a ramp when a boat is in the water;

FIG. 5 is a side view of a vehicle ramp in accordance with the preferred embodiments;

FIG. 6 is a front view of the vehicle ramp shown in FIG. 5 taken along the line 6-6 and enlarged slightly to show more detail;

FIG. 7 is an enlarged side view of a wedge-shaped member 520 shown in FIGS. 5 and 6;

FIG. 8 is a front view of the wedge-shaped member 520 taken along the line 8-8 in FIG. 7;

FIG. 9 is a perspective view of the wedge-shaped member 520 shown in FIGS. 5-8;

FIG. 10 is a cross-sectional view showing the second elongated channel that is part of the sliding member of the vehicle ramp;

FIG. 11 is a top view of the sliding member of the vehicle ramp;

FIG. 12 is a bottom view of the sliding member of the vehicle ramp;

FIG. 13 is a front view of the first elongated channel that is part of the fixed member of the vehicle ramp;

FIG. 14 is a top view of the first elongated channel shown in FIG. 13;

FIG. 15 is an exploded perspective view showing the components that make up the fixed member of the vehicle ramp in a preferred embodiment;

FIG. 16 is an enlarged side view of the rear of the sliding member of the vehicle ramp;

FIG. 17 is an enlarged side view of the sliding member of the vehicle ramp as it contacts fixed stop members on the fixed member;

FIG. 18 is an enlarged side view of the sliding member of the vehicle ramp after it is pivoted downward;

FIG. 19 is a side view of the vehicle ramp deployed in water so people and pets can use the vehicle ramp to get back into a boat after swimming in the water; and

FIG. 20 is a side view of a semi tractor showing the ramp disclosed herein mounted under the door portion so a person or pet can easily walk up the ramp into the cab.

### DETAILED DESCRIPTION

A vehicle ramp has a fixed member attached to the underside of a vehicle and a sliding member that slides in and out of the fixed member. The sliding member is captivated within the fixed member so the sliding member cannot be inadvertently removed from the fixed member during normal use of the vehicle ramp. The fixed member includes a support member upon which a portion of the sliding member rests when the sliding member is fully slid out of the fixed member to a fully deployed position and pivoted downward, thereby defining a maximum angle of the sliding member with respect to the fixed member. This angle is preferably less than 45 degrees below horizontal. When mounted to the underside of a boat, the sliding member can be deployed while the boat is on the water, with the result that the sliding member will have one end in the water at the angle defined by the support member, thereby allowing people or dogs to use the ramp to climb back into the boat after swimming in the water.

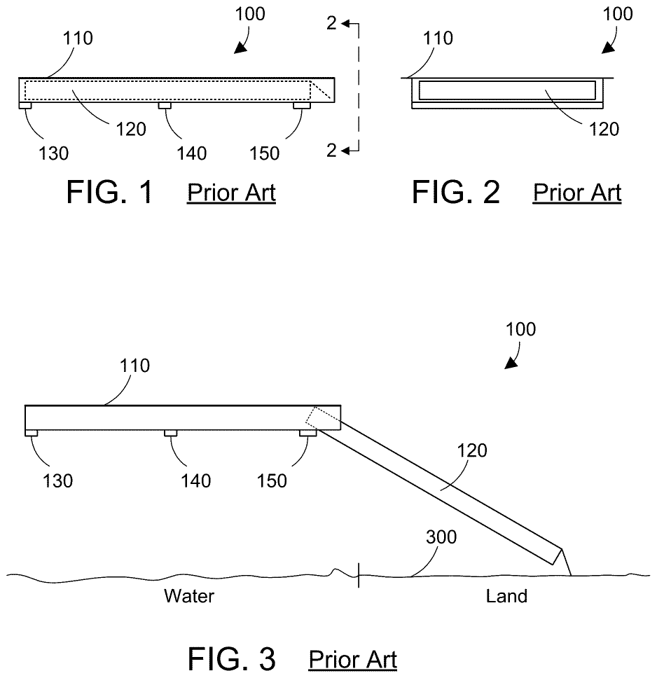

Referring to FIGS. 1-4, a prior art boat ramp 100 for pontoon boats is shown. The boat ramp 100 includes a fixed portion 110 that is attached to the underside of a pontoon boat and a slidable portion 120 that can slide in an out of the fixed portion 110. The fixed portion 110 includes flanges on both sides as shown in FIG. 2 that can be attached to the underside of the pontoon boat using screws. FIG. 3 shows the boat ramp 100 with the slidable portion 120 slid out of the fixed portion 110 and pivoted down to contact the ground 300, such as on the bank of a lake. This allows people, pets and cargo to be loaded onto the boat using the slidable portion 120 as a loading ramp for the boat.

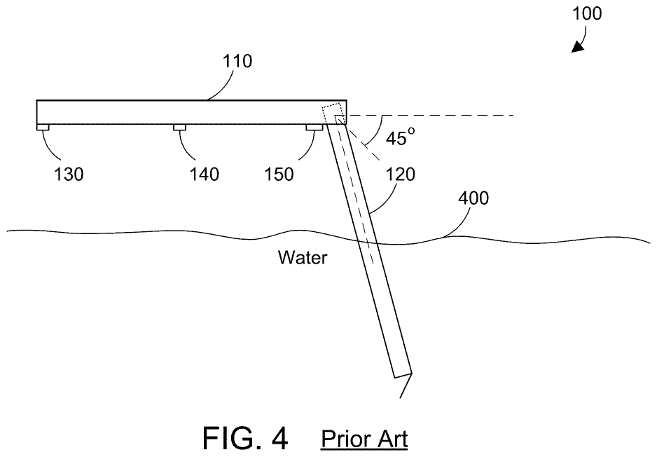

The slidable portion 120 of the known boat ramp 100 is designed for the end of the slidable portion to contact the ground 300, as shown in FIG. 3. There is no support member in the prior art boat ramp 100 that keeps the slidable portion 120 at any defined angle with respect to the fixed portion 110. This is illustrated in FIG. 4. If the prior art boat ramp 100 were deployed while a boat was on water 400, the end of the slidable portion 120 would fall down into the water at an angle greater than 45 degrees from horizontal, making the slidable portion 120 unusable as a ramp when deployed on the water 400.

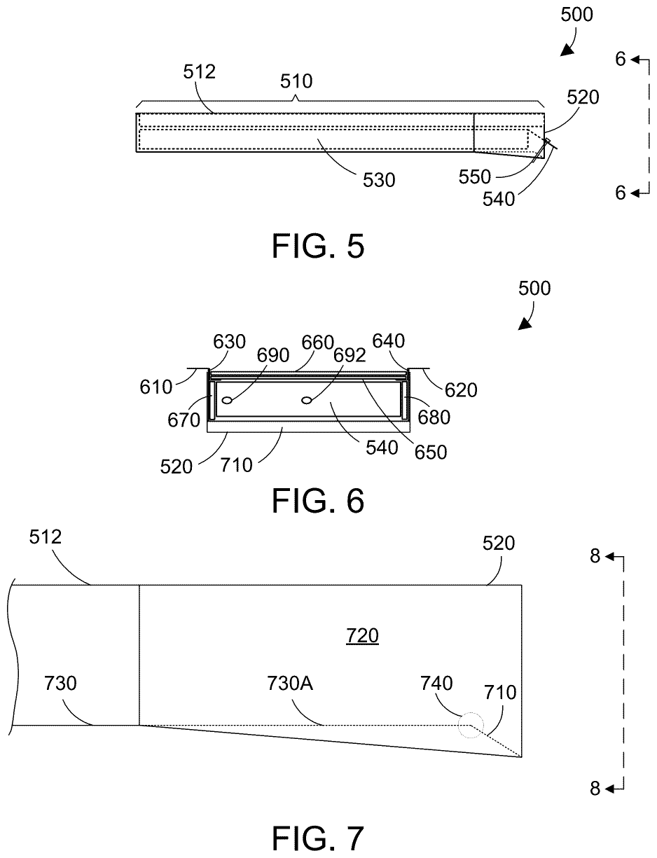

In contrast to the known vehicle ramp shown in FIGS. 1-4, the vehicle ramp 500 disclosed and claimed herein provides a support member that maintains a sliding member of the ramp at a predefined angle less than 45 degrees below horizontal, more preferably less than 35 degrees below horizontal, and most preferably less than 30 degrees below horizontal. Note, however, that lesser angles, such as 20 degrees below horizontal, could also be used. Referring to FIGS. 5-20, vehicle ramp 500 includes a fixed member 510 that is typically attached to the underside of a vehicle, where the fixed member 510 includes a first channel member 512 and a wedge-shaped member 520. The vehicle ramp 500 further includes a sliding member 530 that is captivated within and slides with respect to the fixed member 510. The sliding member 530 includes an angled end 540. Referring to FIG. 6, the angled end 540 may include a hole 690 through which a locking pin 550 as shown in FIG. 5 may be placed to lock the sliding portion 530 in position with respect to the fixed portion 510. A second hole 692 allows a strap to be attached to the angled end 540, which helps a person to deploy the sliding portion 530 by grabbing the strap and pulling the strap up and out to slide the sliding portion 530 out of the fixed portion 510.

FIG. 6 is an end view of the ramp 500 in FIG. 5 taken along the line 6-6. The wedge-shaped portion 520 includes a support member 710 that supports the sliding portion 530 when the sliding portion 530 is fully slid out of the fixed portion 510 to a fully deployed position. A preferred configuration for support member 710 is shown in FIGS. 6-9 to be an angled planar surface. As shown in FIG. 6, the wedge-shaped member 720 is a channel-shaped member that slips over the outside of the channel-shaped member that makes up the first channel member 512. Referring to FIG. 7, a bottom 730 of the first channel member 512 extends through the wedge-shaped member 720 as shown at 730A until it meets with the end of the support member 710. The end of the bottom 730A of the channel member 512 is then attached to the end of the support member 710 along a line in the area shown at 740 in FIG. 7, preferably by welding. The result is a flat bottom 710 and 730A of the first channel member 512 that is substantially planar, with the support member 710 defining a predefined angle for the sliding portion 530 when the sliding portion 530 is slid completely out of the fixed member to a fully deployed position.

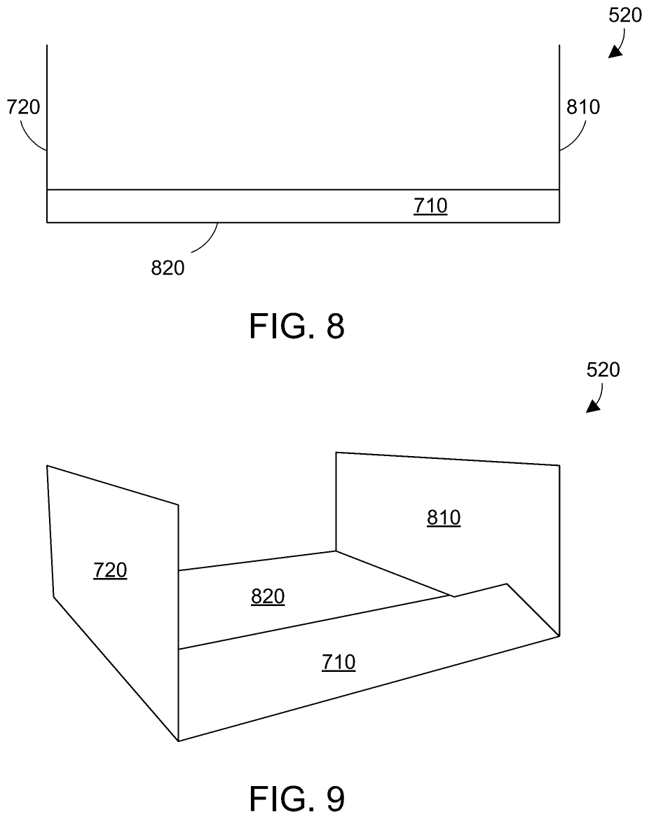

FIG. 8 shows an end view of the wedge-shaped portion 520 in FIG. 7 taken along the line 8-8. The wedge-shaped portion 520 includes a left side 720 and a right side 810 that are spaced to receive the outside of the first channel member 512. A bottom 820 of the wedge-shaped member 520 is shown in FIGS. 8 and 9. The support member 710 is preferably attached to an end of the first channel member 512 at 740 shown in FIG. 7 after the wedge-shaped member 520 is slid over the outside of the first channel member 512.

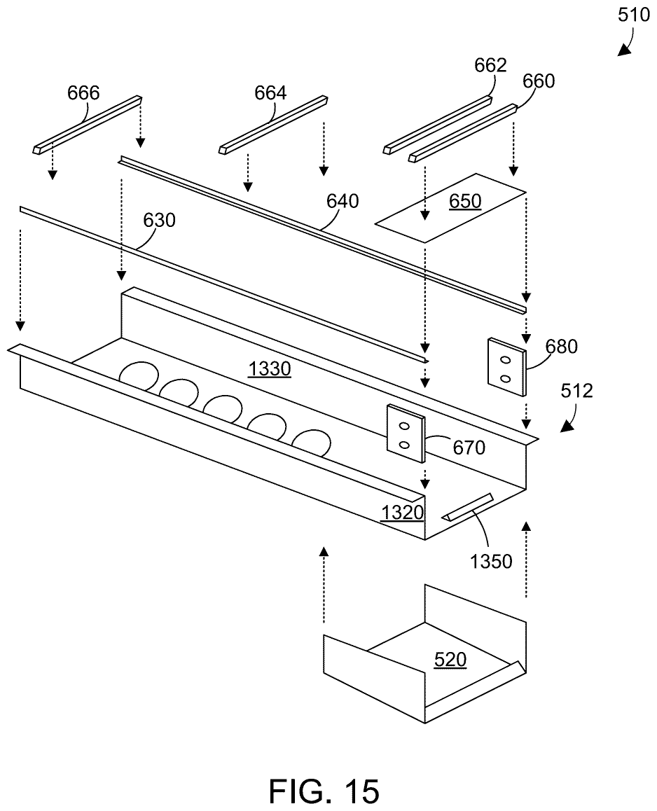

The end view of the ramp 500 shown in FIG. 6 shows the channel member 512 includes a left flange 610 and a right flange 620 that are used to attach the fixed portion 510 to the underside of a vehicle, preferably using screws, rivets or other known attachment mechanisms. Angle members 630 and 640 are attached to the inside of the first channel member 512, with a plate 650 and multiple supports, one of which is 660 in FIG. 6, attached to a top of the first channel member 512. The details of the components shown in FIG. 6 are better viewed in the exploded view of FIG. 15.

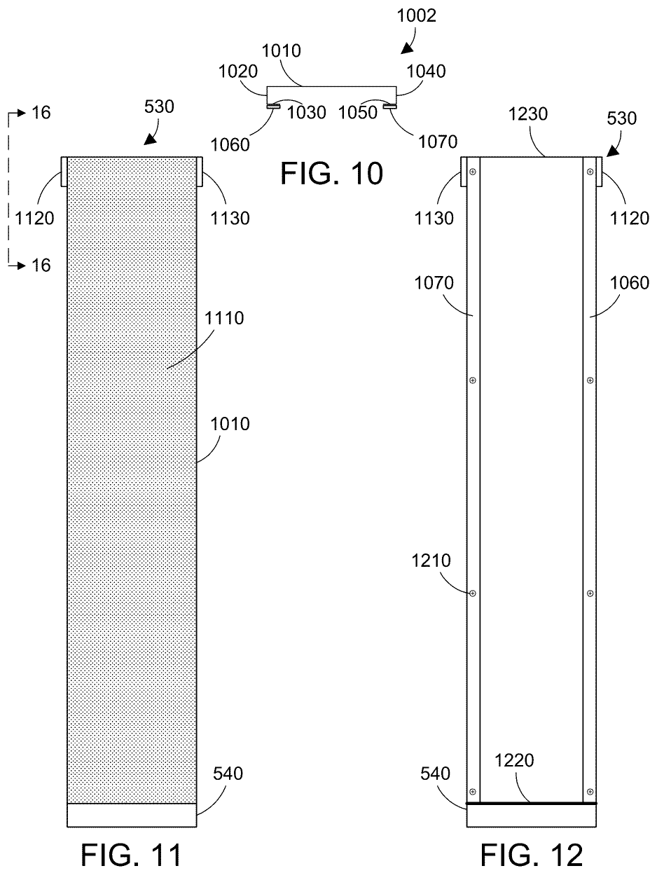

One suitable configuration for the sliding member 530 in accordance with the preferred embodiments is shown in FIGS. 10-12. FIG. 10 shows a cross-section of a second channel member 1002 that makes up most of the sliding member 530. The second channel member 1002 includes a top 1010, a left side 1020, a left bottom portion 1030, a right side 1040, a right bottom portion 1050, a left slide strip 1060 on the bottom of the left bottom portion 1030, and a right slide strip 1070 on the bottom of the right bottom portion 1050. The left slide strip 1060 and right slide strip 1070 are preferably made of a rectangular piece of plastic sheet material, such as nylon. However, any suitable material could be used for slide strips 1060 and 1070. Slide strips 1060 and 1070 are shown in FIG. 12 to be attached using one or more screws, shown by way of example at 1210 in FIG. 12. The slide strips 1060 and 1070 are used to provide a durable surface on which the weight of the sliding member can be suitably carried and further serve as the wear points as the sliding member 530 is slid out and in with respect to the fixed member 510.

The second channel member 1002 preferably has the cross-sectional configuration shown in FIG. 10. This configuration could be manufactured in many suitable ways. For example, a rectangular tubular piece of aluminum could have the middle portion of its bottom cut out. In the alternative, the second channel member 1002 could be extruded aluminum. In the most preferred embodiment, the second channel member 1002 is made by bending flat aluminum stock into the shape shown in FIG. 10 using a sheet metal brake. The bends create load bearing strength that make it possible to use thinner material that would otherwise be needed for a particular application. The preferred embodiments extend to any suitable way to form the second channel member in the sliding member, whether currently known or developed in the future.

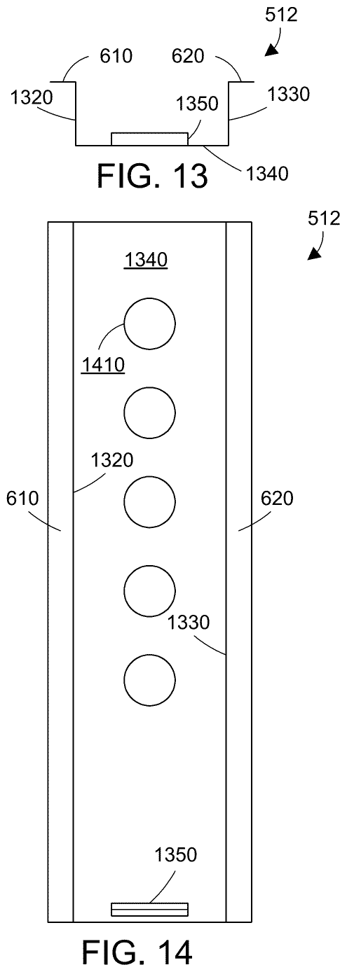

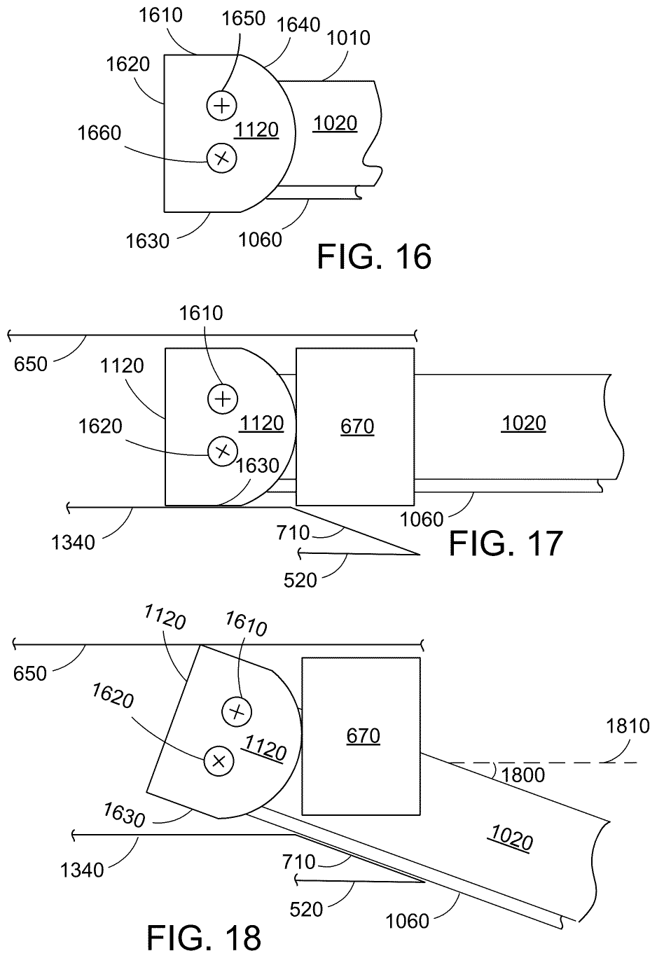

Referring to FIG. 11, the sliding member 530 preferably includes an angled end 540 and two stop members 1120 and 1130 on each side of the second channel member 1002. The stop members 1120 and 1130 are preferably made of a plastic material such as nylon, but could be made of any suitable material. The stop members 1120 and 1130 contact corresponding stop members in the fixed member 510 when the sliding member 530 is slid out to a fully deployed position, as explained in more detail below with respect to FIGS. 16-18. The sliding member 530 also includes a front edge 1220 shown in FIG. 12 that engages a retaining member 1350 shown in FIGS. 13-15 on the first channel member 1300 of the fixed member 510 so the sliding member 530 is held in its fully retracted position. The sliding member 530 may also include a back edge 1230. In the most preferred implementation, the angled end 540 and back edge 1230 are bent from the same piece of flat stock as the rest of the second channel member 1010, while the front edge 1220 is a separate piece, typically attached by welding.

Referring to FIG. 11, a top 1010 of the sliding member 530 preferably includes an anti-slip surface 1110, shown by the dotted surface in FIG. 11. The anti-slip surface 1110 can be provided in any suitable way, including manufacturing the second channel member 1002 with a rough surface, or adhering one or more pieces to the top of the second channel member 1002. In the most preferred implementation, the anti-slip surface 1110 is provided by adhering a sheet of abrasive anti-slip floor tape to the top 1010 of the second channel member 1002. The abrasive anti-slip floor tape can have any suitable roughness, but practical experience has found that 60 grit is suitable as an anti-slip surface for the vehicle ramp described herein. The anti-slip surface allows both people and dogs to more easily climb up the ramp, and is especially helpful in helping dogs to gain enough traction to climb up the ramp when the ramp it deployed in the water. While in a preferred embodiment most or all of the top 1010 is covered with the anti-slip surface 1110 as shown in FIG. 11, it is also within the scope of the claimed invention to provide multiple separate portions, such as horizontal strips of anti-slip floor tape or dots of anti-slip floor tape, that covers less than all of the top 1010.

FIGS. 13 and 14 show details of a first channel member 512 in the fixed member 510 in accordance with the preferred embodiments. The first channel member 512 preferably has a channel cross-section as shown in FIG. 13. First channel member 512 includes a left flange 610, a right flange 620, a left side wall 1320, a right side wall 1330, and a bottom 1340. Note that bottom 1340 in FIG. 13 is one suitable example for bottom 730 and 730A shown in FIG. 7. The left flange 610 and right flange 620 are preferably used to attach the fixed member to the underside of a vehicle. For example, pontoon boats and tri-toon boats typically have aluminum structural members running crosswise between the pontoons. The fixed member 510 can be easily attached to the aluminum structural members on the underside of a pontoon or tri-toon boat using self-tapping screws to screw the flanges 610 and 620 to the aluminum structural members of the boat.

A retaining member 1350 is provided at the front of the first channel member 512 as shown in FIG. 14 to hold the sliding member 530 inside the fixed member 510 when the sliding member 530 is fully retracted inside the fixed member 510. When the sliding member is fully retracted, the front edge 1220 of the sliding member 530 is placed behind the retaining member 1350, which would be just above the retaining member 1350 in FIG. 4. This is done typically by lifting the front of the sliding member 530 slightly once the sliding member is mostly retracted, allowing the front edge 1220 to pass above and past the retaining member 1350. Gravity will then keep the sliding member 530 in its retracted position by the front edge 1220 of the sliding member 530 engaging the retaining member 1350. While this retention mechanism works well in many circumstances, such as when a boat is on the water, a secondary retaining mechanism may be needed when the boat is put on a trailer. If the boat were pulled down a bumpy road, the bumps could cause the front edge 1220 of the sliding member 530 to move upwards and past the retaining member 1350, causing the sliding member 530 to slide out of the fixed member as the boat is being towed down the road. The alleviate this potential problem, the sliding member 530 can have a hole in the angled end 540, as shown at 690 in FIG. 6, and a corresponding hole in the support member 710, so a locking pin 550 shown in FIG. 5 can be placed through the angled end 540 and through the support member 710 to lock the sliding member 530 in place with respect to the fixed member 510.

The retaining member 1350 can have any suitable shape or profile. In the specific configuration shown in FIGS. 13-15, the retaining member 1350 is triangular in shape, such as a portion of a piece of angle material with its two edges welded onto the bottom 1340. This triangular shape helps the front edge 1220 of the sliding member 530 to slide up and past the retaining member 1350 to retain the sliding member 530 in its retracted position, and to slide up and past the retaining member 1350 when the sliding member 530 is deployed.

The top view of the first channel member 512 shown in FIG. 14 shows the inclusion of one or more holes, one example of which is 1410 in FIG. 14. The holes 1410 make the first channel member 512 lighter, and also provide a pathway for water to drain out of the first channel member 512. While the holes 1410 are optional, in the preferred embodiments they provide the advantage of less weight and the ability to drain water as described above.

The first channel member 512 in FIGS. 13 and 14 can be manufactured in any suitable way. One way is to extrude the first channel member. Another way is to stamp the first channel member from flat stock. In the most preferred embodiment, the first channel member 512 is formed using flat stock that is bent to the configuration shown in FIG. 13 using a sheet metal brake.

An exploded view of the fixed portion 510 is shown in FIG. 15. The inside of the wedge-shaped member 520 slides over the outside of the first channel member 512, and the front edge of the first channel member 512 is then attached to the edge of the support member 710 as described above at 740 shown in FIG. 4, typically by welding. The wedge-shaped portion 520 and first elongated portion 512 can also be welded an any suitable locations where the two meet. Two angle members 630 and 640 are attached to the inside part of the sides 1320 and 1330. A flat front plate 650 is then attached to the angle members 630 and 640. Support rods 660 and 662 are then attached to the flat plate 650 and angle members 630 and 640. Additional support rods can also be added, including support rods 664 and 666 shown in FIG. 15. Stop members 670 and 680 are attached to an inside of the sides 1320 and 1330 of the first channel member 512, typically using screws or other suitable fasteners.

The stop members 1120 and 1130 on the sliding member 530 engage with the stop members 670 and 680 on the fixed member 510 when the sliding member 530 is slid out to its fully deployed position. This is shown and described with respect to FIGS. 16-18. FIG. 16 shows a side view of the left stop member 1120 in FIG. 11. The left stop member 1120 has a flat top 1610, a flat left side 1620, a flat bottom 1630, and curved right side 1640. The left stop member 1120 is preferably attached to the side 1020 of the second channel member using screws 1650 and 1660. The slide strip 1060 is also shown in FIG. 16 attached to the bottom of the left side 1020 of the second channel member.

The left stop member 1120 preferably extends below the slide strip 1060, as shown in FIG. 16. The right stop member 1130 has a similar shape and configuration. The two stop members 1120 and 1130 provide a relatively narrow contact point for the back side of the sliding member 530 on the fixed member 510. The slide strips 1060 and 1070 make contact with the front of the first channel member 512 as the sliding member 530 is slid out of and into the fixed member 510. The result is minimal friction and resistance to the sliding member 530 as it slides out of and into the fixed member 510.

FIG. 17 shows the engagement of the stop member 1120 on the sliding member 530 with the corresponding stop member 670 on the fixed member 510 when the sliding member 530 is slid out into its fully deployed position. Note the screw holes in retaining member 670 are not shown in FIGS. 17 and 18 for the sake of clarity. Also shown in FIGS. 17 and 18 is the bottom of plate 650 and the bottom 1340 of the first channel member 512, along with the support member 710 on the wedge-shaped member 520. Once the sliding member 530 is slid out until its stop members 1120 and 1130 engage the corresponding stop members 670 and 680 on the fixed member 510, as shown in FIG. 17, the end of the sliding member 530 can then be pivoted down as shown in FIG. 18. The curved surface of the stop member 1120 allows the stop member 1120 to pivot smoothly with respect to the stop member 670 until the slide strip 1060 rests atop the support member 710. The combination of the top plate 650, stop member 670 and support member 710 on the fixed member 510 captivate the sliding member 530 so it is held at a predetermined angle 1800 that is preferably less than 45 degrees, more preferably less than 35 degrees, and most preferably less than 30 degrees below horizontal. When the stop members 1120 and 1130 contact the corresponding stop members 670 and 680 when the second elongated channel is slid to a fully deployed position outside of the elongated fixed member, these stop members prevent removal of the second elongated channel from the elongated fixed member by captivating the back end of the sliding member 530 within the fixed member 510.

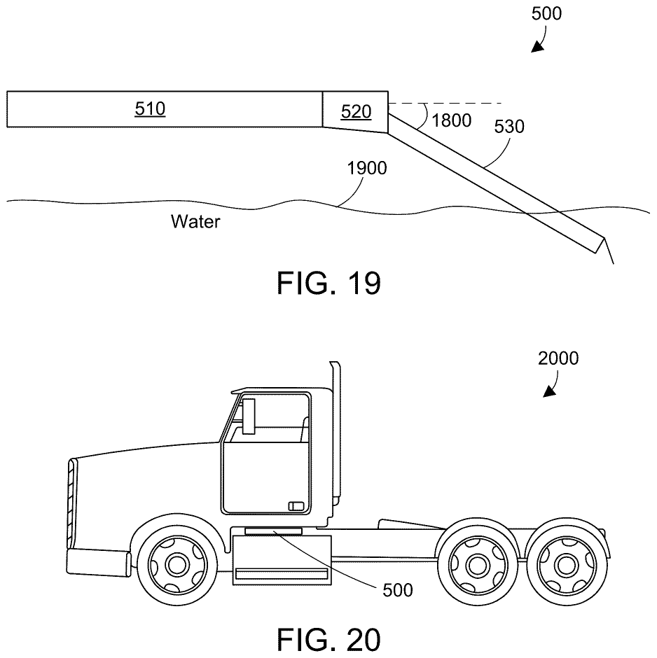

When mounted on a boat, the vehicle ramp can thus be deployed while the boat is in the water, as shown in FIG. 19. The result is the slidable portion 530 is held at the predetermined angle 1800 such that an end of the slidable portion is in the water, thereby allowing people and dogs to easily climb back into the boat after swimming in the water.

While the vehicle ramp has been discussed herein with reference to boats, the vehicle ramp could be used on any suitable vehicle. For example, FIG. 20 shows the vehicle ramp 500 attached to the underside of the cab of a semi tractor. Many truck drivers have dogs or cats. The vehicle ramp 500 described herein attached to a semi tractor 2000 as shown in FIG. 20 allows the sliding portion to be deployed and placed on the ground, allowing people or pets to easily climb into the cab of the semi tractor 2000. From the example shown in FIG. 20, one of ordinary skill in the art will appreciate the vehicle ramp 500 could be used on many different types of vehicles. For example, the vehicle ramp 500 could be mounted to the underside of a recreational vehicle (RV) near its door, thereby allowing people and pets to go up the sliding member of the vehicle ramp to enter the RV or to exit the RV and go down the vehicle ramp when the sliding member is deployed and placed on the ground. The vehicle ramp could also be used on a utility trailer. In one suitable embodiment, a single vehicle ramp that is wide could be attached to the underside of a utility trailer, allowing vehicles such as riding lawnmowers and cars or trucks to be driven onto the utility trailer. Of course, multiple vehicle ramps could also be used, such as two vehicle ramps on a car hauler trailer that are spaced to accommodate the spacing between car tires. The vehicle ramp described and claimed herein can be used on any suitable vehicle where a ramp is needed and where the vehicle has a substantially flat surface on its underside to mount the vehicle ramp.

While the support member 710 is shown herein as an angled planar surface in the most preferred embodiment, other configurations could also be used within the scope of the claimed invention. For example, the wedge-shaped member 520 could include a round rod or other support member running between its two sides within the region 740 shown in FIG. 7. The support member 710 can be any suitable shape or configuration, as long as it holds or helps to hold the sliding member 530 at a predetermined angle below horizontal.

Note the predetermined angle of the sliding member discussed above is discussed in terms of an angle below horizontal. This is normally achieved by mounting the fixed member in a substantially horizontal plane underneath a vehicle, and providing the support member that provides the predetermined angle of the sliding member with respect to horizontal. However, the predetermined angle below horizontal could also be provided when the fixed member is mounted on a non-horizontal plane. For example, let's assume a boat has an underside that has a 10 degree downward angle. If the desired predetermined angle with respect to horizontal is 30 degrees, and the fixed portion is mounted on the underside of the boat at a 10 degree downward angle, the support member could have an angle of 20 degrees, which would then provide a desired 30 degree angle with respect to horizontal. This simple example illustrates the angle of the sliding member with respect to the fixed member as determined by the support member may vary to provide the predetermined angle below horizontal.

The dimensions for the vehicle ramp can vary within the scope of the preferred embodiments. Pontoon boats with two pontoons are very-well known, and have been around for decades. The prior art pontoon boat ramp shown in FIGS. 1-4 and discussed above is suitable for use on known pontoon boats that have only two pontoons. Boats with three pontoons, often called “tri-toon” boats, are becoming more popular. The prior art pontoon boat ramps have a width that does not allow them to be used on tri-toon boats because the prior art pontoon boat ramp has a width greater than the distance between pontoons on a tri-toon boat. The dimension of the vehicle ramp disclosed herein can be sufficiently narrow to place between two of the pontoons on a tri-toon boat. Of course, the vehicle ramp disclosed herein could also be used on pontoon boats, with the same narrower version used on both pontoon boats and tri-toon boats, and a wider version used on pontoon boats that would not fit on a tri-toon boat. In addition, the vehicle ramp can have any suitable width and length according to the vehicle and desired application. For example, if a more gentle angle is desired when the vehicle ramp is used on a boat and deployed in the water, the ramp can be made with a longer length and a support member that supports the sliding portion at a lesser angle from horizontal, such as 20 degrees. The disclosure and claims herein expressly extend to any suitable dimensions for the vehicle ramp.

The vehicle ramp can also be made from any suitable material. In the most preferred embodiments, for use on boats such as pontoon boats and tri-toon boats, most of the vehicle ramp is made from sheet aluminum, angle aluminum, tubular aluminum stock and plate aluminum, and the aluminum components are welded together. The first channel member 512 and second channel member 1002 are preferably bent from 0.100 inch (2.5 mm) flat aluminum sheet stock, such as 3003 H14. Any suitable method to join the pieces together could be used, including without limitation welding, mechanical fasteners such as rivets, screws, nuts and bolts, etc., adhesives, etc. Making the vehicle ramp out of aluminum provides strength in a lightweight material that will not corrode over time and is very resistant to water. When used in a saltwater environment, the aluminum can be coated with a suitable coating to extend its life from the corrosive effects of salt water. Of course, any suitable material could be used, including any suitable natural or manmade material, including without limitation metal, carbon fiber or other composite materials, plastic, fiberglass, etc. The specific materials used will depend on the specific application. For example, when two of the vehicle ramps are used on a car hauler trailer, the vehicle ramps will be made of painted steel of sufficient thickness to provide the needed strength to support the weight of vehicles loaded onto the car hauler trailer.

The disclosure and claims herein support a vehicle ramp comprising: a fixed member that is configured to be fixedly attached to an underside of a vehicle, wherein the fixed member comprises a support member; and a sliding member slidably coupled to the fixed member, wherein the sliding member is configured to slide out of the fixed member and pivot down until at least a portion of the sliding member rests on the support member of the fixed member, thereby maintaining the sliding member at a predefined angle less than 45 degrees below horizontal.

The disclosure and claims herein further support a boat ramp comprising: a fixed member that is configured to be fixedly attached in a substantially horizontal position on the underside of a boat, wherein the fixed member comprises: a first elongated channel; a wedge-shaped channel member fixedly coupled to the first elongated channel, wherein the wedge-shaped channel member comprises an angled support member at a predefined angle less than 45 degrees below horizontal; and

a sliding member slidably coupled to the fixed member, the sliding member comprising a second elongated channel and configured to slide out of the fixed member and pivot down until at least a portion of the second member rests on the angled support member of the fixed member, thereby maintaining the sliding member at the predefined angle.

The disclosure and claims herein additionally support a boat ramp comprising: an elongated fixed member that is configured to be fixedly attached in a substantially horizontal position on the underside of a boat, wherein the elongated fixed member comprises: a first elongated channel; a wedge-shaped channel member fixedly coupled to the first elongated channel, wherein the wedge-shaped channel member comprises an angled support member at a predefined angle less than 45 degrees below horizontal; and first and second stop members fixedly attached to an inside of corresponding first and second sides the first elongated channel; and an elongated sliding member slidably coupled to the elongated fixed member, wherein the elongated sliding member comprises: a second elongated channel; at least one plastic slide strip fixedly attached to an underside of the second elongated channel; and third and fourth stop members fixedly attached to an outside of corresponding first and second sides of the second elongated channel such that the third and fourth stop members contact the first and second stop members when the second elongated channel is slid to a fully deployed position outside of the elongated fixed member, thereby preventing removal of the second elongated channel from the elongated fixed member; and wherein the elongated sliding member is configured to slide out of the elongated fixed member and pivot down until at least a portion of the second elongated channel rests on the angled support member of the elongated first member, thereby maintaining the elongated sliding member at the predefined angle.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. A vehicle ramp comprising:
a fixed member that is configured to be fixedly attached to an underside of a vehicle, wherein the fixed member comprises a support member; and
a sliding member slidably coupled to the fixed member, wherein the sliding member is configured to slide out of the fixed member and pivot down until at least a portion of the sliding member rests on the support member of the fixed member, thereby maintaining the sliding member at a predefined angle less than 45 degrees below horizontal.

2. The vehicle ramp of claim 1 wherein the predefined angle is less than 35 degrees below horizontal.

3. The vehicle ramp of claim 1 wherein the predefined angle is less than 30 degrees below horizontal.

4. The vehicle ramp of claim 1 wherein when the vehicle ramp is fixedly attached to a substantially horizontal underside of a boat, the sliding member can be slid out of the fixed member until the at least a portion of the sliding member rests on the support member, resulting in a portion of the sliding member being underwater when the boat is on water.

5. The vehicle ramp of claim 1 wherein the vehicle comprises a boat.

6. The vehicle ramp of claim 5 wherein the boat comprises a pontoon boat.

7. The vehicle ramp of claim 6 wherein the pontoon boat comprises a tri-toon boat.

8. The vehicle ramp of claim 1 wherein the vehicle comprises a semi tractor.

9. The vehicle ramp of claim 1 wherein the vehicle comprises a recreational vehicle.

10. The vehicle ramp of claim 1 wherein the vehicle comprises a trailer.

11. The vehicle ramp of claim 1 wherein a top of the second member comprises an anti-slip surface.

12. The vehicle ramp of claim 11 wherein the anti-slip surface comprises an abrasive anti-slip floor tape.

13. A boat ramp comprising:
a fixed member that is configured to be fixedly attached in a substantially horizontal position on the underside of a boat, wherein the fixed member comprises:
a first elongated channel;
a wedge-shaped channel member fixedly coupled to the first elongated channel, wherein the wedge-shaped channel member comprises an angled support member at a predefined angle less than 45 degrees below horizontal; and
a sliding member slidably coupled to the fixed member, the sliding member comprising a second elongated channel and configured to slide out of the fixed member and pivot down until at least a portion of the second member rests on the angled support member of the fixed member, thereby maintaining the sliding member at the predefined angle.

14. The boat ramp of claim 13 wherein the fixed member further comprises at least one stop member fixedly attached to the first elongated channel, and wherein the second member further comprises at least one stop member fixedly attached to the second elongated channel such that the second member is captivated within the first elongated channel of the fixed member.

15. The boat ramp of claim 14 wherein the at least one stop member fixedly attached to the first elongated channel comprises first and second stop members on an inside of corresponding first and second sides of the first elongated channel.

16. The boat ramp of claim 15 wherein the at least one stop member fixedly attached to the second elongated channel comprises third and fourth stop members on an outside of corresponding first and second sides of the second elongated channel.

17. The boat ramp of claim 16 wherein the third and fourth stop members contact the first and second stop members when the second elongated channel is slid to a fully deployed position outside of the fixed member, thereby preventing removal of the second elongated channel from the fixed member.

18. The boat ramp of claim 13 wherein an underside of the second elongated channel comprises at least one slide strip fixedly attached to an underside of the second elongated channel.

19. A boat ramp comprising:
(A) an elongated fixed member that is configured to be fixedly attached in a substantially horizontal position on the underside of a boat, wherein the elongated fixed member comprises:
a first elongated channel;
a wedge-shaped channel member fixedly coupled to the first elongated channel, wherein the wedge-shaped channel member comprises an angled support member at a predefined angle less than 45 degrees below horizontal; and
first and second stop members fixedly attached to an inside of corresponding first and second sides the first elongated channel; and
(B) an elongated sliding member slidably coupled to the elongated fixed member, wherein the elongated sliding member comprises:
a second elongated channel;
at least one plastic slide strip fixedly attached to an underside of the second elongated channel; and
third and fourth stop members fixedly attached to an outside of corresponding first and second sides of the second elongated channel such that the third and fourth stop members contact the first and second stop members when the second elongated channel is slid to a fully deployed position outside of the elongated fixed member, thereby preventing removal of the second elongated channel from the elongated fixed member; and
wherein the elongated sliding member is configured to slide out of the elongated fixed member and pivot down until at least a portion of the second elongated channel rests on the angled support member of the elongated first member, thereby maintaining the elongated sliding member at the predefined angle.

20. The boat ramp of claim 16 wherein the first and second stop members comprise a substantially flat surface and the third and fourth stop members each comprise a curved surface that contacts the substantially flat surfaces of the first and second stop members when the elongated sliding member is slid to the fully deployed position.
